(19) United States
(12) Patent Application Publication
(10) Pub. No.: US 2017/0245609 A1
(43) Pub. Date: Aug. 31, 2017

(54) Combination knife and key organizer in one compact unit

(71) Applicant: Bryce Alexander, Costa Mesa, CA (US)

(72) Inventor: Bryce Micheal Alexander, Costa Mesa, CA (US)

(21) Appl. No.: 15/387,546

(22) Filed: Dec. 21, 2016

Related U.S. Application Data
(60) Provisional application No. 62/270,860, filed on Dec. 22, 2015.

(51) Int. Cl. A45C 11/00; B26B 1/04; B26B 11/00

(52) U.S. Cl. CPC A45C 11/00; B26B 11/001; B26B 1/042

(57) ABSTRACT

A combination pocket device (FIG. 8) is provided for holding a knife blade that pivots between a closed position where it lives inside the body of the device, and an extended position where it extends co-linear with the body in a locked state. The blade is held in position by a lock-back mechanism. The keys are held together by a bolt on one side of the blade and lives inside the body as well. The keys fold in opposite position of the blade, into one organized and compact unit.

### BACKGROUND OF THE INVENTION

The present invention relates to a combination device meant to be carried in a person's pocket that serves a multitude of useful applications. This device is one organized and compact unit that is a solution for bulky key rings that also has multi-tools and knives that are dangling from a key ring. This unit solves that problem by housing these items in one organized and compact unit.

Specifically, the device is meant to include a knife and key holder/organizer all combined in a single unit. The one single unit houses a blade and keys and does not need to be attached to anything.

There are known devices that organize keys but none that house keys and a locking knife blade (or any knife blade for that matter). This device bridges the gap between carrying bulky keys and a pocket knife separately. You now can carry your keys and pocket knife in one device.

Most people carry keys within their pocket, but do without a knife because it becomes burdensome to carry such additional articles. The problem with carrying two or more separate articles is that the separate articles can become lost, misplaced, or feel uncomfortable when one is carrying all of these articles in a pocket.

You can find separate key chains and separate folding knives that are of a size to fit in one's pocket; but, a single device that incorporates keys and knife in a compact and efficient package has not been heretofore contemplated.

### SUMMARY OF THE INVENTION

It is an object of this invention to provide a device that yields the functions of cutting articles and organizing keys in a row. Another object of the invention is to provide a device that is compact in form and comfortably fits within a person's pocket.

It is a further object of the invention to provide a combination device that is easy to use, inexpensive to manufacture, and simple and elegant in design.

Other objects of the invention will be apparent hereinafter from the specification and from the recital of the appended claims, particularly when read in conjunction with the accompanying drawings. The present invention comprises a combination device that includes a pair of body portions for holding a knife blade that pivots between a closed position where it is sandwiched between the body portions, and an extended position where it extends co-linear with the body in a locked state. The device is of a compact form to easily fit into one's pocket and is not significantly more bulky than a conventional key ring with an ornamental or promotional body attached. Yet, the device is much more useful than a conventional key ring and body because it provides an extendable knife blade for allowing one to cut an envelope, package, string, tape, paper, etc.

### DRAWING FIGURE DESCRIPTION

FIG. 1: is front perspective view of the invention.

FIG. 2: is an exploded perspective view of the invention.

FIG. 3: is a right side elevation view.

FIG. 4: is a left perspective view.

FIG. 5: is a front elevation view showing keys deployed.

FIG. 6: is a front elevation view showing keys hidden in storage.

FIG. 7: is a front elevation view showing the knife blade deployed.

FIG. 8: Combination key organizer and knife shown with a one of a kind blade that is a knife and bottle opener in one (as one of several blade options).

FIG. 9: Instruction Manual that comes with product.

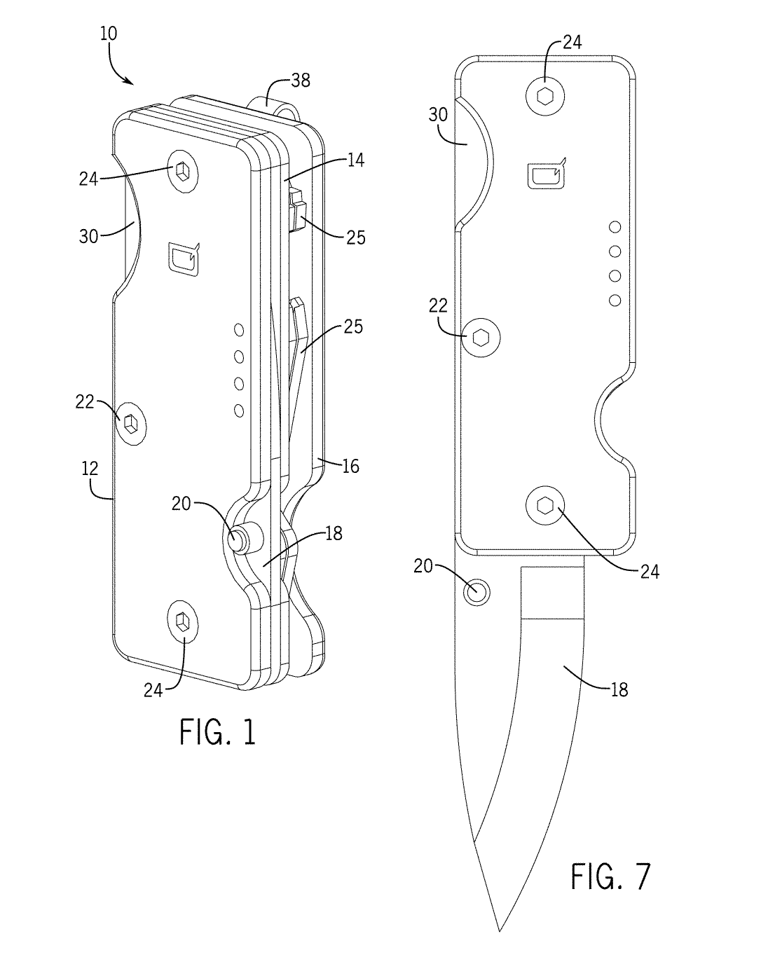

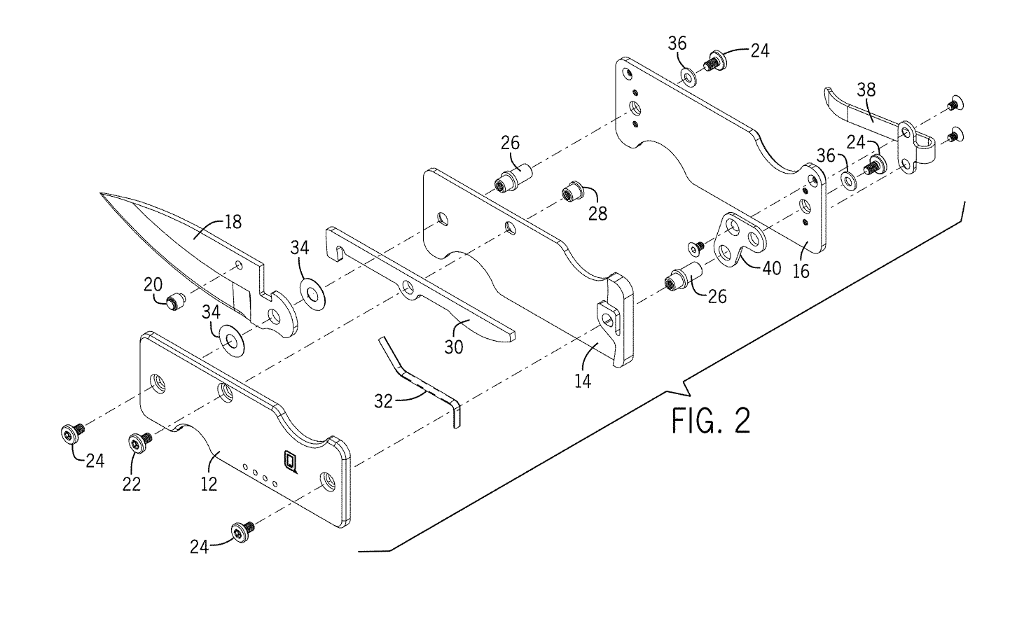

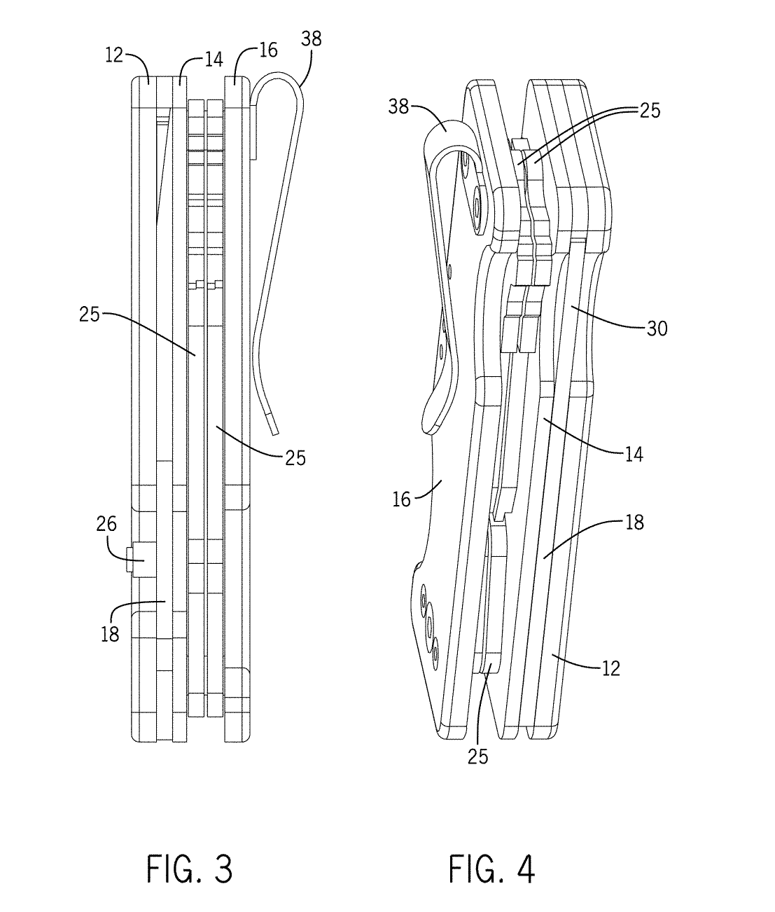

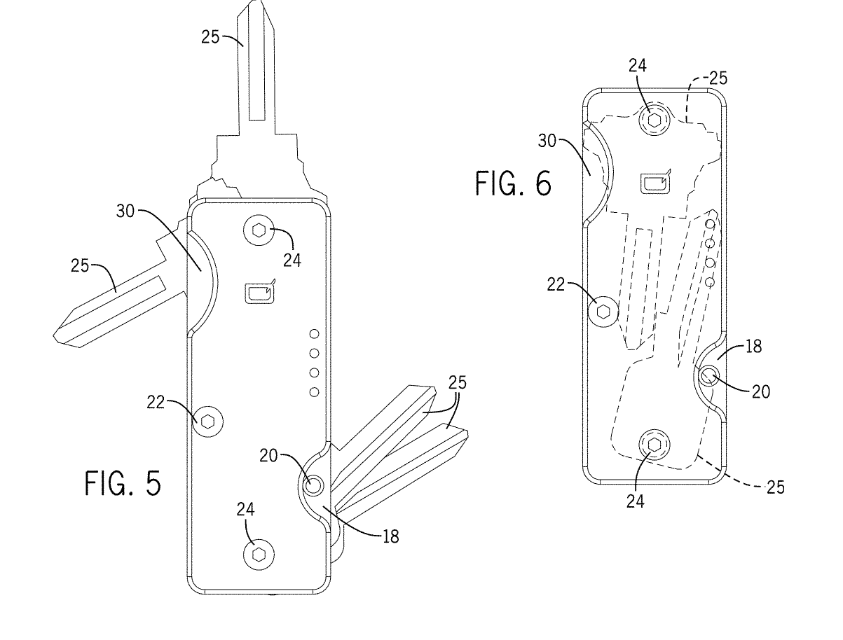

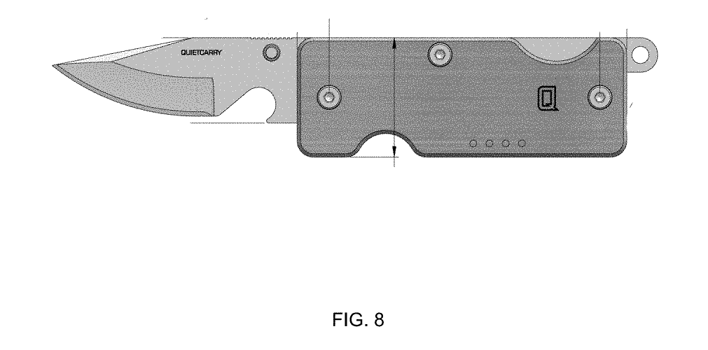

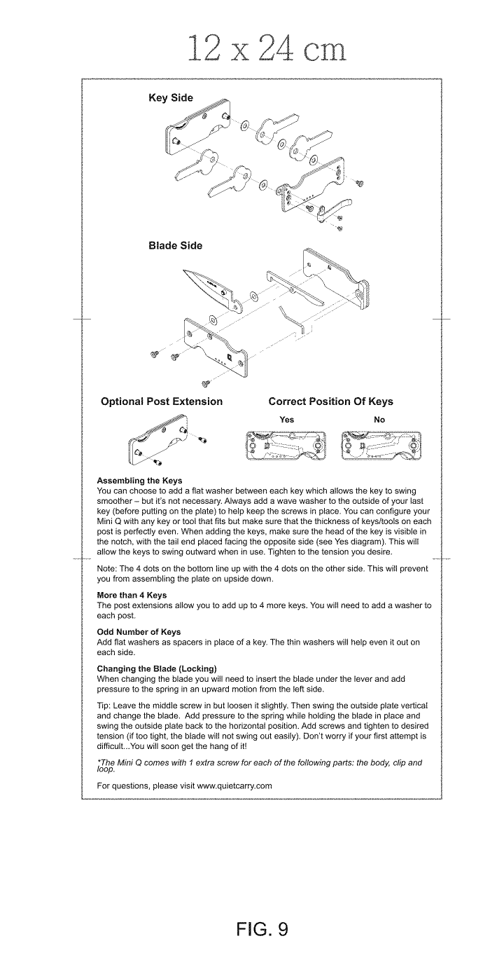

### ITEMIZED PARTS LIST

10: is the overall combination knife & key holder invention.

12: is the front body plate.

14: is the middle body plate.

16: is the rear body plate.

18: is the knife blade.

20: is the thumb stud.

22: are the body screws.

24: is a pivot screw, a unique one of a kind Detent design (locking screw)

25: are the keys.

26: are the body posts.

28: is the blade pivot post, a unique one of a kind double pivot post

30: is the pivotable latch.

32: is the tension spring.

34: are the pivot washers.

36: are the body washers.

38: is the clip.

40: is the optional key loop.

What is claimed is:

1-3. (canceled)

4. A combination pocket device comprising: a body portion; a knife blade having a cutting edge, ability to move blade into the body portion to a closed position and ability to move blade out of body portion to an extended position where cutting edge is exposed.

5. A pin holds the blade and rotates on axis in an open and close action. When the blade is extended it is held securely in lock position with a spring lock-back knife mechanism. To unlock the blade, you push in the bottom of the mechanism to release the pressure, allowing a closing action.

6. The device unit has a space where keys are added and held together with a bolt which is then tightened securely with a rubber gasket, allowing tension adjustments. The keys are now secured into the same unit as the knife and may be folded out individually (opposite of the blade) and used conveniently to unlock or lock. The keys then fold back in, into one multi-purpose compact unit.
